(19) United States
(12) Patent Application Publication
(10) Pub. No.: US 2016/0070273 A1
(43) Pub. Date: Mar. 10, 2016

(54) PREVENTION OF DISEASES VIA ARTIFICIAL SOIL EXPOSURE

(71) Applicant: International Business Machines Corporation, Armonk, NY (US)

(72) Inventors: Sasha P. Caskey, New York, NY (US); Robert G. Farrell, Cornwall, NY (US); Dimitri Kanevsky, Ossining, NY (US); Jonathan Kanevsky, Montreal (CA); Tara N. Sainath, New York, NY (US); Frances W. West, Newton, MA (US)

(21) Appl. No.: 14/482,045

(22) Filed: Sep. 10, 2014

(51) Int. Cl. G05D 11/00; G05B 15/02

(52) U.S. Cl. CPC G05D 11/00; G05B 15/02

(57) ABSTRACT

A system and methods for determining and delivering soil composition for preventing allergic diseases. An example method includes providing a computer network which communicates with health sensors and environmental sensors. The method, includes providing environmental sensors in a first geographic region to measure environmental conditions of the first geographic region. The method also includes providing health sensors for a sample human population in the first geographic region to measure health conditions of the sample human population. The method also includes computing a soil model that prevents allergic diseases based on the environmental conditions and the health conditions, and synthesizing artificial soil that replicates the computed soil model.

### BACKGROUND

This invention relates to disease prevention, and more particularly to integrated systems for preventing diseases using artificial soil.

Recent scientific developments indicate that the increased incidence of allergic diseases among children in current generation is a consequence of the increased cleanliness of their environment as babies. For example, the hygiene hypothesis states that the increased prevalence of autoimmunity and allergic diseases in affluent, industrialized countries may be attributed to decreased exposure to dirt and infectious agents.

Accordingly, one example aspect of the present invention is a method for determining soil composition for preventing allergic diseases. The method includes providing a computer network that communicates with health sensors and environmental sensors. The method includes providing environmental sensors in a first geographic region to measure environmental conditions of the first geographic region. The method also includes providing health sensors for a sample human population in the first geographic region to measure health conditions of the sample human population. The method also includes computing a soil model that prevents allergic diseases based on the environmental conditions and the health conditions, and synthesizing artificial soil that replicates the computed soil model.

Another example aspect of the present invention is a system for determining soil composition for preventing allergic diseases. The system includes a computer network and a plurality of environmental sensors in a first geographic region to measure environmental conditions of the first geographic region. The environmental sensors are in communication with the computer network. A plurality of health sensors for a sample human population in the first geographic region measure health conditions of the sample human population. The health sensors are also in communication with the computer network. A computer processor computes a soil model that prevents allergic diseases based, on the environmental conditions and the health conditions. The computer processor is in communication with the computer network. The system further includes artificial soil that replicates the computed soil model.

Yet another example aspect of the present invention is an artificial soil spray system for prevention of allergic diseases. The system includes a pressurized container, a propellant in the pressurized container for sustaining pressure in the pressurized container, and artificial soil mixture in the pressurized container. The artificial soil mixture including minerals, water, and organic material.

### BRIEF DESCRIPTION OF THE DRAWINGS

The subject matter which is regarded, as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C show flowcharts depicting a method for determining soil composition for preventing allergic diseases in accordance with one embodiment of the invention.

FIG. 2 shows a diagram depicting a system for determining soil composition for preventing allergic diseases in accordance with another embodiment of the invention.

FIG. 3 shows artificial soil for prevention of allergic diseases in accordance with an embodiment of the invention.

FIG. 4 shows an artificial soil spray system for prevention of allergic diseases in accordance with an embodiment of the invention.

FIG. 5 shows a system for improving human health and immunity in accordance with an embodiment of the invention.

FIG. 6 shows the environmental health cognition, module of the system for improving human health and immunity in accordance with an embodiment of the invention.

FIG. 7 shows the environmental health analytics module of the system for improving human health and immunity in accordance with an embodiment of the invention.

FIG. 8 shows the reproduction of the embedded environment module of the system for improving human health and immunity in accordance with an embodiment of the invention.

FIG. 9 shows a patient centric care module in accordance with an embodiment of the invention.

### DETAILED DESCRIPTION

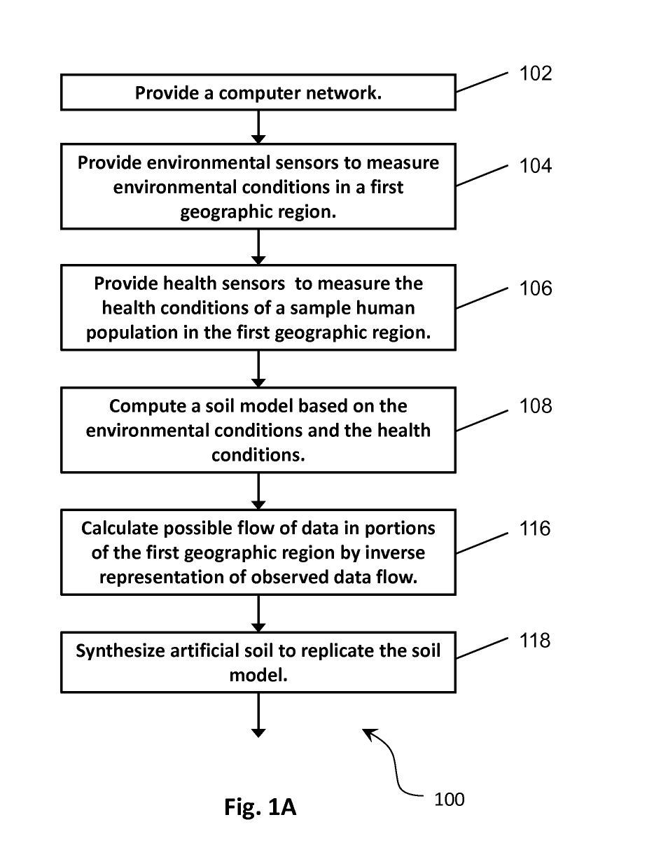

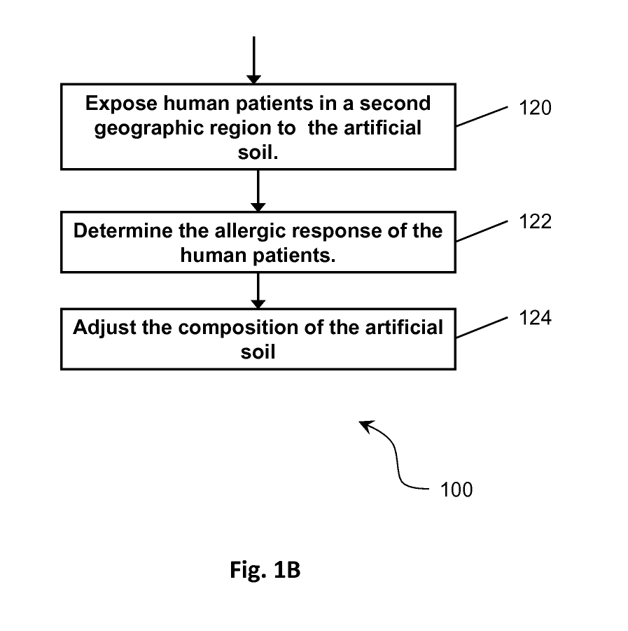

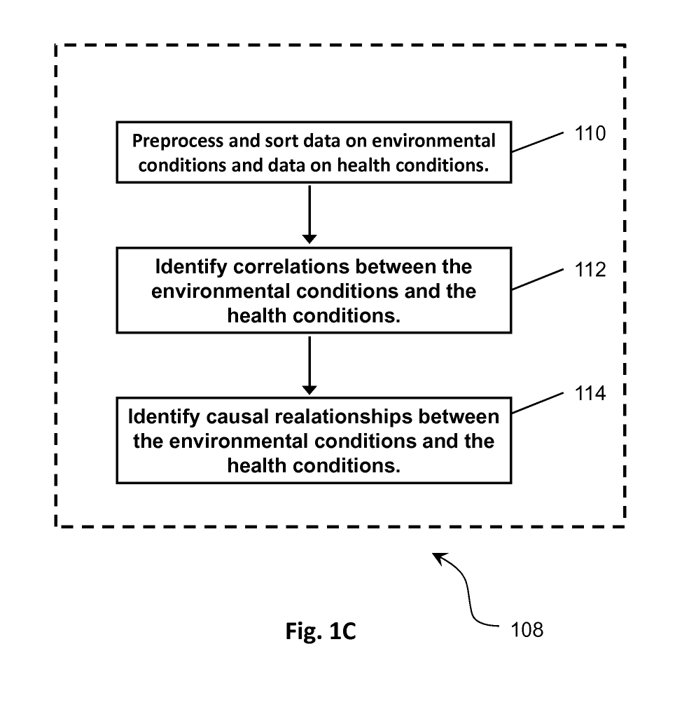

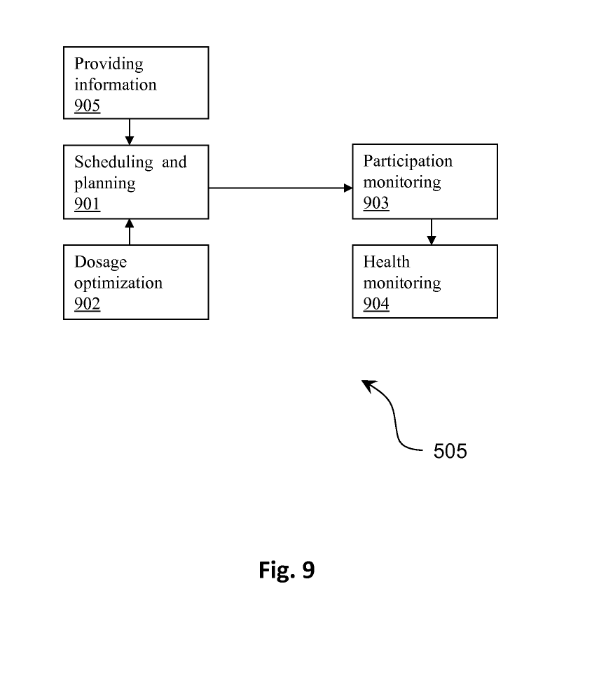

The present invention is described with reference to embodiments of the invention. Throughout the description of the invention reference is made to FIGS. 1A-9. When referring to the figures, like structures and elements shown throughout are indicated with like reference numerals.

FIGS. 1A-1C show flowcharts depicting a method 100 for determining soil composition for preventing allergic diseases in accordance with one embodiment of the invention. The artificial soil may increase the immunological response of human patients, such as babies and toddlers, without causing harm. The method begins with a network provision step 102, as shown in FIG. 1A. At the network provision step 102, a computer network is provided.

After the network provision step 102, the method proceeds to the environmental sensor provision step 104, as shown in FIG. 1A. At the environmental sensor step provision 104, environmental sensors are provided in a first geographic region. The environmental sensors may measure the environmental conditions of the first geographic region and communicate these environmental sensors to the computer network. The environmental sensors may include soil sensors that measure native soil composition of the first geographic region.

After the environmental sensor provision step 104, the method proceeds to the health sensor provision step 106, as shown in FIG. 1A. At the health sensor provision step 106, health sensors are provided in the first geographic region. The health sensors may measure the health conditions of a sample human population in the first geographic region. The health sensors may also communicate the health conditions to the computer network. The health sensors may include allergy sensors that measure the allergic responses of the sample human population.

After the health sensor provision step 106, the method 100 proceeds to the soil model computation step 108, as shown in FIG. 1A. At the soil model computation step 108, a soil model that prevents allergic diseases is computed based on the environmental conditions and the health conditions.

As shown in FIG. 1C, the soil model computation step 108 may include a data processing step 110, followed by a correlation step 112, and subsequently followed by a causal relationship identification step 114. At the data processing step 110, data on the environmental conditions and data on the health conditions are preprocessed and sorted. At the correlation step 112, correlations between the environmental conditions and the health conditions are identified. At the causal relation identification step 114, causal relationships between the environmental conditions and the health conditions are identified.

Returning to FIG. 1A, after the soil model computation step 108, the method proceeds to the inverse representation of data step 116. At the inverse representation of data step, the possible flow of data in sections of the first geographic region 206 not accessible via direct sensor installation is calculated using inverse representation of observed data flow.

After the inverse representation of data step 116, the method proceeds to the artificial soil synthesis step 118, as shown in FIG. 1A. At the artificial soil synthesis step 118, artificial soil that replicates the computed soil model is synthesized. The artificial soil synthesis step 118 may also include cleaning and removing dangerous components from native soil in the first geographic region 206. The artificial soil may be obtained from rural environments.

After the artificial soil synthesis step 118, the method 100 proceeds to the artificial soil exposure step 120, as shown in FIG. 1B. At the artificial soil exposure step 120, human patients in a second geographic region are exposed to the artificial soil.

After the artificial soil exposure step 120, the method proceeds to the allergic response step 122, as shown in FIG. 1B. At the allergic response step 122, allergic responses by the human patients are determined and/or detected.

After the allergic response step 122, the method proceeds to the artificial soil adjustment step 124, as shown in FIG. 1B. At the artificial soil adjustment step 124, the composition of the artificial soil is adjusted based on the allergic responses by the human patients.

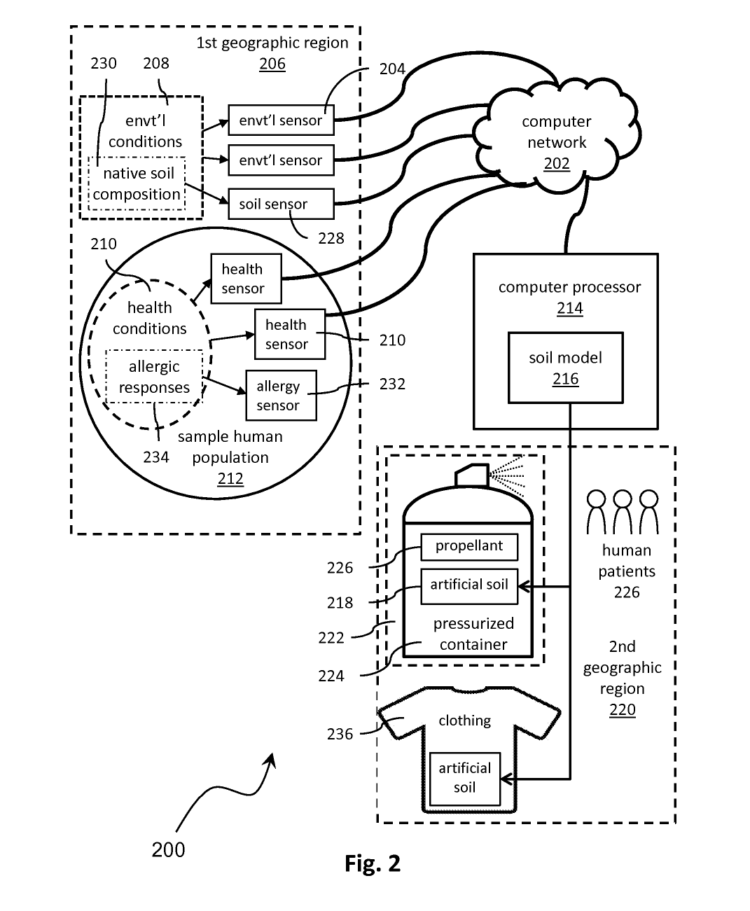

FIG. 2 shows a diagram depicting a system 200 for determining soil composition for preventing allergic diseases in accordance with another embodiment of the invention. The system 200 includes a computer network 202, environmental sensors 204, health sensors 206, a computer processor 208, and artificial soil 210.

The environmental sensors 204 are located in a first geographic region 206. The environmental sensors 204 measure environmental conditions 208 of the first geographic region 206. The environmental sensors 204 are in communication with the computer network 202. The environmental sensors 204 may include soil sensors 228 to measure native soil composition 230 of the first geographic region 206.

The health sensors 206 measure the health conditions 210 of a sample human population 212 in the first geographic region 206. The health sensors 206 are also in communication with the computer network 202. The health sensors 206 may include allergy sensors 232 to measure allergic responses by the sample human population 212.

The computer processor 208 computes a soil model 216 that prevents diseases, including allergies, based on environmental sensors 208 and health sensors 210. The computer processor 208 is also communication with the computer network 202.

The artificial soil 218 replicates the computed soil model 216. The artificial soil 218 may include a mixture of minerals, water, gases, and organic material. The minerals may also be 45% the mixture by weight. Water may be 25% of the mixture by weight. The gases may be 25% of the mixture by weight. The organic material may be 5% of the mixture by weight. The minerals in the artificial soil 218 may be selected from a group consisting of sand, silt, clay, quartz, silicon dioxide and limestone. The organic material in the artificial soil 218 may be selected from the group consisting of hydrocarbons or plant residues.

According to one embodiment of the invention, the system 200 may include an artificial soil spray 222 for exposing human patients to the artificial soil 218 in a second geographic region 220. The artificial soil spray 222 may include a pressurized container 224 and a propellant 226 in the pressurized container 224. The pressurized container 224 may enclose the artificial soil 218. The propellant 226 may sustain pressure in the pressurized container 224.

According to another embodiment of the invention, the system 200 may include clothing that carries the artificial soil 218.

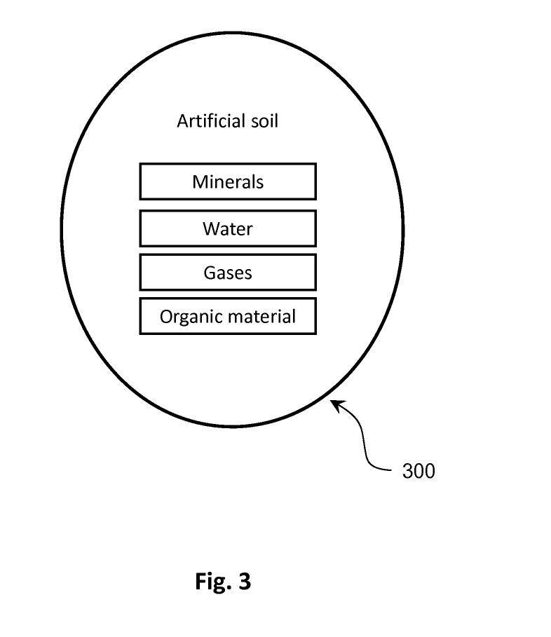

FIG. 3 shows artificial soil 300 for prevention of allergic diseases according to an embodiment of the invention.

In a particular embodiment, the artificial soil 300 includes a mixture of minerals, water, gases, and organic material. The minerals may be 45% of the mixture by weight. Water may be 25% of the mixture by weight. The gases may be 25% of the mixture by weight. Organic material may be 5% of the mixture by weight.

The minerals of the artificial soil 300 may be selected from a group consisting of sand, silt, clay, quartz, silicon dioxide and limestone. The organic material may be selected from a group consisting of hydrocarbons or plant residues.

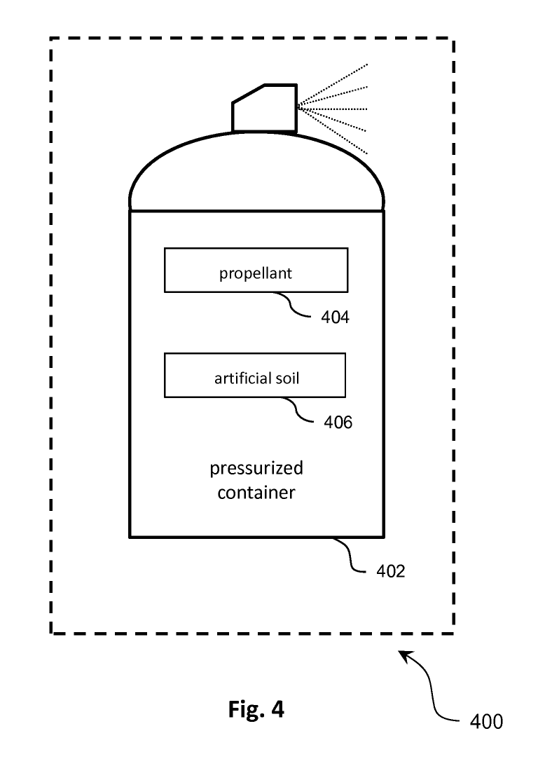

FIG. 4 snows an artificial soil spray system 400 for prevention of allergic diseases. The artificial soil spray system includes a pressurized container 402, a propellant 404, and an artificial soil mixture 406.

The propellent 404 is contained in the pressurized container 402 and sustains pressure in the pressurized container 402. The artificial soil mixture 406 is also contained in the pressurized container 402 and includes minerals, water, and organic material. The minerals may be 45% of the mixture by volume. Water may be 25% of the mixture by volume. Organic material may be 5% of the mixture by volume. The minerals of the artificial soil 406 may be selected from a group consisting of sand, silt, clay, quartz, silicon, dioxide and limestone. The organic material may be selected from a group consisting of hydrocarbons or plant residues.

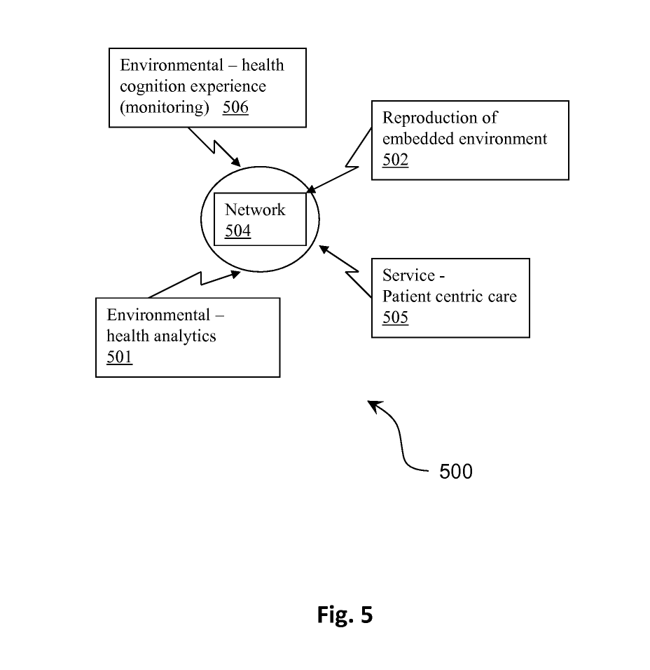

FIG. 5 shows a system 500 for improving human health and immunity. The system 500 involves a computer network 504 and four modules—environmental health cognition 506, environmental health analytics 501, reproduction of the embedded environment 502, and patient centric care 503. The computer network 504 sends and receives data among the modules.

Environmental health cognition 506 may involve preprocessing data into a more representative form. Preprocessing of data may utilize hierarchical learning or sparse representations. Environmental health cognition 506 may take place over an extended period of time, for example, monitoring and collecting data over many years.

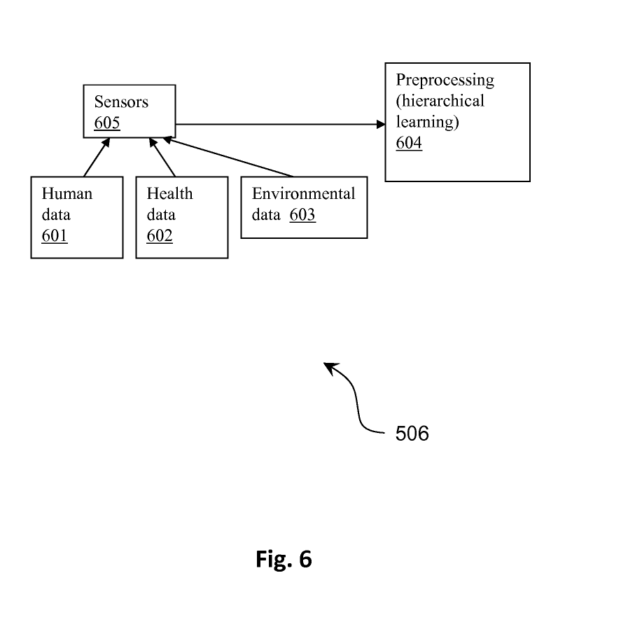

As shown in FIG. 6, environmental health cognition 506 involves utilizing a distributed system of sensors 605 to collect human data 601, health data 602, and environmental data 603. Human data 601 may include visual, audio, tactile, and time and location of individuals in a sample human population. Human data 601 may also include the individuals' nutrition information. Health data 602 describe the health of the individuals in the sample human population. Health data 602 may include the individuals' body temperatures, hydration, heart rates, and pulse. Environmental data 603 refers to information on the physical environment of the individuals in the sample human population. Environmental data 604 may include soil composition, atmospheric composition, humidity, environmental temperature, and information on local precipitation.

Returning to FIG. 5, environmental health analytics 501 involves processing data generated, via environmental health cognition 506. Environmental health analytics 501 finds relationships and/or correlations between environmental data and the health data, and identifies the positive and negative effects of various environmental factors on human health. According to an embodiment of the invention, environmental health analytics 501 may be used to correlate children's health with the kind of soil in their physical environment. If multiyear data is available, environmental health analytics 501 may be used to correlate current health data with past environmental data and/or past behavioral data. According to an embodiment of the invention, environmental health analytics 501 may also identify correlations between a patient's asthma or allergy and the patient's behavior prior to the diagnosis of the asthma or allergy.

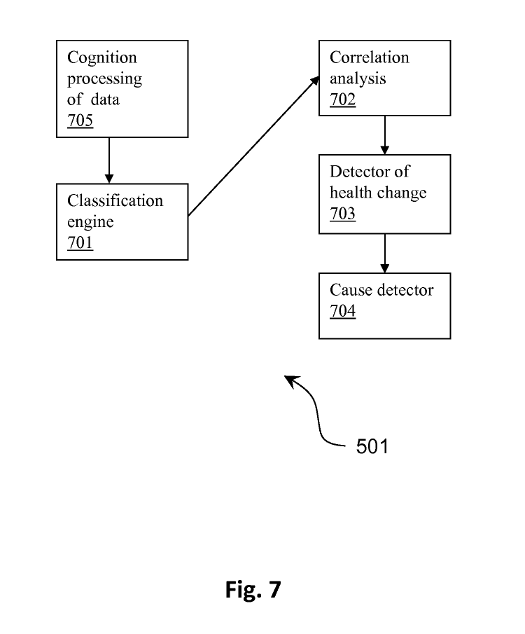

As shown in FIG. 7, environmental health analytics 501 may include cognition processing of data 705, a classification engine 701, correlation analysis 702, a health change detector 703, and a cause detector engine 704.

Cognition processing of data 705, for example, processes data generated from environmental health cognition 506. Cognition processing of data 705 may be performed via a neural network. The processed data may then be passed to a classification engine 701. The classification engine 701 may sort and classify the human, health, and environmental data into classes such as, for example, soil type, the presence or absence of allergens, the type of allergen present, and the individual's age.

Correlation analysis 702 identifies correlations, if any, between health data and either behavioral or environmental data.

The health change detector 703 assesses the strength of the correlation between environmental data and health data.

The cause detector 704 identifies the presence or absence of a causal relationship between strongly correlated environmental data and health data. The cause detector 704 also determines the presence or absence of a causal relationship between strongly correlated behavioral data and health data.

Returning to FIG. 5, reproduction of the embedded environment 502 involves reproduction of the environment identified by environmental health analytics 501 to have a positive effect on human health. Reproduction of the embedded environment 502 may include reproduction of specific environments or behaviors which produce a positive effect on human health. Positive effects on human health may include greater immunity against diseases and lower incidence of childhood asthma and childhood allergies.

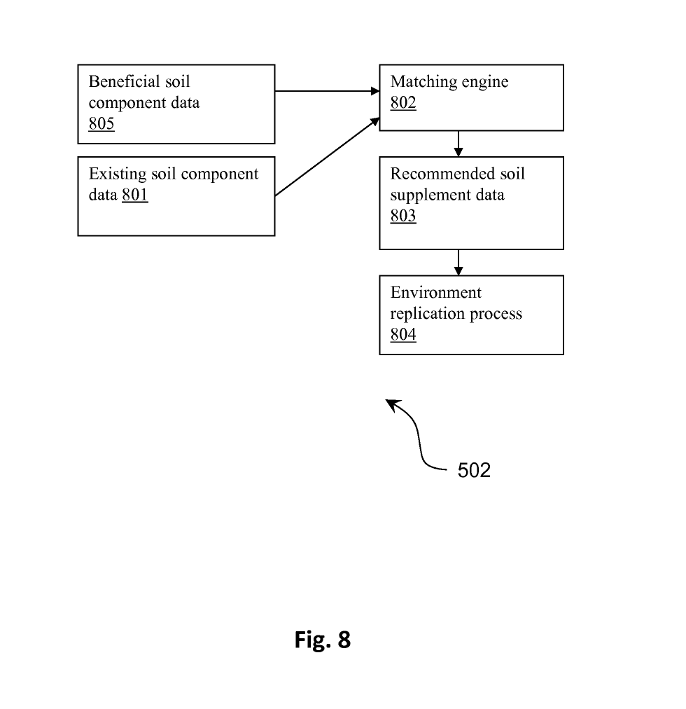

As shown in FIG. 8, reproduction of the embedded environment 502 includes existing soil component data 801, beneficial soil component data 805, a matching engine 802, recommended soil supplement data 803, and an environment replication process 804.

Existing soil component data 801 refers to information regarding the components of the ground in a target geographic area. The ground may include sand, dirt, soil, gravel, and other surface matter.

Beneficial soil component data 805 refers information on soil components that may have positive effects on human health. A positive effect on human health may include improving childhood immunity against disease.

The matching engine 802 may compare beneficial soil component data 805 against existing soil component data 801 and compile recommended soil supplement data 803, which are components beneficial to human health that are lacking in the environment of the target geographic area.

An environment replication process 804 then uses the recommended soil supplement data 803 to create environments intended to improve human health. The environment replication process 804 may include adding beneficial organic material (animal or plant) to native soil. The environment replication process may also include synthesizing artificial soil. According to an embodiment or the invention, the artificial soil may be dispensed using a spray.

Returning to FIG. 5, patient centric care refers to the patient service component of system 500. The environmental health cognition 506, environmental health analytics 501, and reproduction of the embedded environment 502 modules all depend on the patient centric care 505 module for health data.

Patient centric care begins with providing information to the patient 905. Providing information involves giving patients information on the effects of the embedded environment on human health.

After providing information to the patient 905, the method proceeds to scheduling and planning step 901. At the scheduling and planning step 901, patients are scheduled for a regimen of visits to the embedded environment.

According to an embodiment of the invention, the scheduling and planning step 901 may also be preceded by a dosage optimization step 902. The dosage optimization step 902 involves determining an optimized regimen of exposure to the embedded environment and may include a determination of the frequency of exposures and length of each exposure.

After the scheduling and planning step 901, the method proceeds to a participation monitoring step 903. At the participation monitoring step 903, the patient's participation is monitored. The patient's participation may also be compared to the prescribed regimen of exposure.

After the participation monitoring step 903, the method proceeds to a health monitoring step 904. At the health monitoring step, the state of the patient's health in reaction to exposure to the embedded environment is assessed. Participation monitoring 904 may also involve informing parents of changes in their child's health after exposure to the embedded environment. According to an embodiment of the invention, participation monitoring may also include providing the local community with general information on the effects of exposure to the embedded environment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection, may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining soil composition for preventing allergic diseases, the method comprising:
providing a computer network;
providing environmental sensors in a first geographic region to measure environmental conditions of the first geographic region, the environmental sensors communicating with the computer network;
providing health sensors for a sample human population in the first geographic region to measure health conditions of the sample human population, the health sensors communicating with the computer network;
computing a soil model that prevents allergic diseases based on the environmental conditions and the health conditions; and
synthesizing artificial soil that replicates the computed soil model.

2. The method of claim 1, wherein the environmental sensors include soil sensors to measure native soil composition of the first geographic region.

3. The method of claim 1, wherein the health sensors include allergy sensors to measure allergic responses by the sample human population.

4. The method of claim 1, further comprising calculating possible flow of data in points of the first geographic region not accessible via direct sensor installation using inverse representation of observed data flow.

5. The method of claim 1, further comprising:
exposing a plurality of human patients to the artificial soil in a second geographic region;
determining allergic responses by the human patients; and
adjusting composition of the artificial soil based on the allergic responses by the human patients.

6. The method of claim 1, wherein synthesizing the artificial soil includes cleaning and removing dangerous components from native soil in the first geographic region.

7. The method or claim 1, wherein computing a soil model includes;
preprocessing and sorting data on the environmental conditions and data on the health conditions;
identifying correlations between the environmental conditions with the health conditions; and
identifying causal relationships between the environmental conditions (or: soil composition in the first geographic region) and the health conditions (or: allergic responses by the sample human population).

8. A system for determining soil composition for preventing allergic diseases, the system comprising:
a computer network;
a plurality of environmental sensors in a first geographic region to measure environmental conditions of the first geographic region, the environmental sensors being in communication with the computer network;
a plurality of health sensors for a sample human population in the first geographic region to measure health conditions of the sample human population, the health sensors being in communication with the computer network;
a computer processor for computing a soil model that prevents allergic diseases based on the environmental conditions and. the health conditions, the computer processor being in communication with the computer network; and
artificial soil that replicates the computed soil model.

9. The system of claim 8, wherein, the environmental sensors include soil sensors to measure native soil composition of the first geographic region.

10. The system of claim 8, wherein the health sensors include allergy sensors to measure allergic responses by the sample human population.

11. The system of claim 8, wherein the artificial soil includes a mixture of minerals, water, gases, and organic material.

12. The system of claim 8, further comprising an artificial soil spray for exposing a plurality of human patients to the artificial soil in a second geographic region.

13. The system of claim 12, wherein the artificial soil spray includes:
a pressurized container enclosing the artificial soil; and
a propellant in the pressurized container for sustaining pressure in the pressurized container.

14. The system of claim 8, further comprising clothing carrying the artificial soil.

15. Artificial soil for prevention of allergic diseases comprising a mixture of minerals, water, gases, and organic material.

16. The artificial soil of 15, wherein the minerals are selected from a group consisting of sand, silt, clay, quartz, silicon dioxide and limestone.

17. The artificial soil of 15, wherein the organic material is selected from a group consisting of hydrocarbons or plant residues.

18. The artificial soil of 15, wherein the minerals are 45% of the mixture by weight, the water is 25% of the mixture by weight, the gases are 25% of the mixture by weight, and the organic material is 5% of the mixture by weight.

19. An artificial soil spray system for prevention of allergic diseases, the system comprising:
a pressurized container;
a propellant in the pressurized container for sustaining pressure in the pressurized container; and
artificial soil mixture in the pressurized container, the artificial soil mixture including minerals, water, and organic material.

20. The spray system of 19, wherein the minerals are selected from the group consisting of sand, silt, clay, quartz, silicon dioxide and limestone.
